(19) United States
(12) Patent Application Publication
(10) Pub. No.: US 2026/0118140 A1
(43) Pub. Date: Apr. 30, 2026

(54) INDUCTIVE ANGULAR POSITION SENSING OVER 360-DEGREE TARGET MEASUREMENT RANGE USING 180-DEGREE SENSOR AREA

(71) Applicant: Microchip Technology Incorporated, Chandler, AZ (US)

(72) Inventors: Ganesh Shaga, Warangal (IN); Surendra Akkina, Hyderabad (IN); Sudheer Puttapudi, Hyderabad (IN)

(21) Appl. No.: 19/208,448

(22) Filed: May 14, 2025

(30) Foreign Application Priority Data
Oct. 31, 2024 (IN) 202441083607

(51) Int. Cl. G01D 5/20

(52) U.S. Cl. CPC G01D 5/2053

(57) ABSTRACT

An apparatus comprises a support structure and a set of coils on, or in, the support structure. The set of coils include one or more oscillator coils, a first sense coil, and a second sense coil. The one or more oscillator coils have a coil winding pattern arranged generally as a half-circle arc-band-shaped ring indicating boundaries of a half annulus. The first sense coil has a coil winding pattern including first, second, third, and fourth lobes. Respective ones of the first, the second, the third, and the fourth lobes are arranged at least generally as quarter-circle arc-band-shaped rings in respective quarter annuluses of the half annulus. The second sense coil has a coil winding pattern including fifth and sixth lobes. Respective ones of the fifth and the sixth lobes are arranged at least generally as half-circle arc-band-shaped rings in respective outer and inner half annuluses of the half annulus.

### PRIORITY CLAIM

This application claims the benefit of the filing date of Republic of India Provisional Patent Application No. 202441083607, filed Oct. 31, 2024, for “Inductive Angular-Position Sensing Over 360 Degree Measurement Range Using 180 Degree Area, Including Related Apparatuses And Methods,” the disclosure of which is hereby incorporated herein in its entirety by this reference.

### FIELD

This disclosure relates generally to inductive angular position sensing. More specifically, some examples relate to inductive angular position sensing for measuring an angular position of a movable target, without limitation. In addition, related apparatuses are disclosed.

### BACKGROUND

If a coil of wire is placed in a changing magnetic field, a voltage will be induced at ends of coil of wire. In a predictably changing magnetic field, the induced voltage will be predictable (based on factors including the area of the coil affected by the magnetic field and the degree of change of the magnetic field). It is possible to disturb a predictably changing magnetic field and measure a resulting change in the voltage induced in the coil of wire. Further, it is possible to create a sensor that measures movement of a disturber of a predictably changing magnetic field based on a change in a voltage induced in a coil of wire.

### BRIEF DESCRIPTION OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1 is a perspective view of an apparatus for inductive angular positioning sensing of a target, according to one or more examples;

FIG. 2 is a top-down view of the apparatus of FIG. 1;

FIG. 3 is a top-down view of a target for use with the apparatus of FIGS. 1 and 2, according to one or more examples;

FIG. 4 is a top-down view of the apparatus of FIGS. 1 and 2 including the target of FIG. 3;

FIG. 5 is a top-down view of one or more oscillator coils of a set of coils of the apparatus of FIGS. 1-4, according to one or more examples, where first and second sense coils of the set of coils are removed for illustrative clarity;

FIGS. 6A and 6B are top-down views of the first sense coil of the set of coils of the apparatus of FIGS. 1-4, according to one or more examples, where the one or more oscillator coils and the second sense coil are removed for illustrative clarity;

FIGS. 7A and 7B are top-down views of the second sense coil of the set of coils of the apparatus of FIGS. 1-4, according to one or more examples, where the one or more oscillator coils and the first sense coil are removed for illustrative clarity;

FIGS. 8A, 8B, 8C, and 8D are respective top-down views of the apparatus for inductive angular position sensing of the target which is rotated at different angular positions, according to one or more examples;

FIG. 9 is a schematic diagram of a position sensing circuitry of an apparatus for inductive angular position sensing, according to one or more examples;

FIG. 10 is a flowchart describing a method of operation of an apparatus for inductive angular position sensing, according to one or more examples;

FIG. 11 is a graph of example demodulated output waveforms of an apparatus for an inductive angular position sensing, according to one or more examples;

FIG. 12 is a plot of an example of a detected angular position of a target of an apparatus for inductive angular position sensing, according to one or more examples;

FIG. 13 is a top-down view of an apparatus for inductive angular position sensing that is known by the inventors of this disclosure; and

FIG. 14 is a block diagram of circuitry that, in some examples, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example of this disclosure to the specified components, steps, features, functions, or the like.

It will be readily understood that the components of the examples as generally described herein and illustrated in the drawing could be arranged and designed in a wide variety of different configurations. Thus, the following description of various examples is not intended to limit the scope of the present disclosure, but is merely representative of various examples. While the various aspects of the examples may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be depicted by block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. For example, data, instructions, commands, information, signals, bits, and symbols that may be referenced throughout this description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal. A person having ordinary skill in the art would appreciate that this disclosure encompasses communication of quantum information and qubits used to represent quantum information.

The various illustrative logical blocks, modules, and circuits described in connection with the examples disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, or a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Position sensors, including angular position sensors are useful. Some examples relate to relates to a non-contacting planar inductive sensor for measuring the position of a movable target. There are many advantages to planar inductive sensing technology, such as: contactless sensing, easy designability on a PCB (with a metallic object as a target), cost-effectiveness, reliability in harsh environments, strong resistance to magnetic fields, and electromagnetic interference (EMI) immunity and/or electromagnetic compatibility (EMC).

An inductive angular position sensor may include an oscillator, one or more excitation coils or oscillator coils, a first sense coil, a second sense coil, and an integrated circuit (e.g., including processing circuitry). Such an inductive angular position sensor may determine an angular position of a target relative to the one or more oscillator coils and/or the sense coils. The oscillator may be configured to generate an excitation signal. The one or more oscillator coils may be excited by the excitation signal. The oscillating signal on the one or more oscillator coils may generate a changing (alternating) magnetic field near and especially within a space encircled by the oscillator coil. The first sense coil and the second sense coil may each encircle a space in which the one or more oscillator coils are capable of generating magnetic field, e.g., a space within the space encircled by the one or more oscillator coils. The changing magnetic field generated by the one or more oscillator coils may induce a first oscillating voltage at ends of the first sense coil and a second oscillating voltage at ends of the second sense coil. The first oscillating voltage at the ends of the first sense coil may oscillate in response to the oscillation of the excitation signal and may be a first sense signal. The second oscillating voltage at the ends of the second sense signal may oscillate in response to the oscillation of the excitation signal and may be a second sense signal.

The target may be positioned relative to the one or more oscillator coils, the first sense coil, and the second sense coil. For example, the target, or a portion of the target, may be positioned above a portion of the one or more oscillator coils, the first sense coil, and the second sense coil, without limitation. The target may disrupt some of the changing magnetic field that passes through one or more loops of the first sense coil and the second sense coil.

The first sense coil and the second sense coil may be configured such that the location of the target, or the portion of the target, above one or more of the first sense coil and the second sense coil may affect the first sense signal and the second sense signal induced in the first sense coil and the second sense coil respectively. For example, the target may disrupt magnetic coupling between the oscillator coil and the sense coils. Such disruption may affect a magnitude of the sense signals in the sense coils. For example, in response to the target, or a portion of the target, being over a loop in the first sense coil, the amplitude of the first sense signal may be less than the amplitude of the first sense signal when the target is not over the loop in the first sense coil.

The target may be configured to rotate (e.g., around an axis, without limitation) such that a portion of the target may pass over one or more loops of one or more of the one or more oscillator coils, the first sense coil and the second sense coil. As the target rotates, each of the first sense signal of the first sense coil and the second sense signal of the second sense coil may be amplitude modulated in response to the rotation of the target and in response to the portion of the target passing over the loops.

The integrated circuit may be configured to generate an output signal responsive to the first sense signal and the second sense signal. The output signal may be a fraction of a rail voltage based on the first sense signal and the second sense signal. The output signal may be related to an angular position of the target, or the position of the portion of the target, and successive samples of the output signal may be related to a direction of movement of the target. Thus, the inductive angular position sensor may be configured to generate an output signal indicative of an angular position of a target. In some examples, the integrated circuit may be configured to generate a first output signal based on the first sense signal and a second output signal based on the second sense signal. The first output signal may be the first sense signal demodulated; the second output signal may be the second sense signal demodulated. Together, the two output signals may be related to an angular position of the target and subsequent samples of the first and second output signals may be indicative of rotation of the target. In some examples, the integrated circuit may be configured to generate a single output signal based on the first sense signal and the second sense signal. Some examples include sense coils and/or targets that cause an integrated circuit to generate a constant-slope output signal in response to rotation of the target, relative to the first sense coil and the second sense coil. The constant-slope output signal may be an output signal with a known correlation between an amplitude of the output signal and the angular position of the target.

In various examples, sense coils and/or targets may be provided with shapes that may cause sense signals from the respective sense coils to exhibit desirable waveform shapes, e.g., waveform shapes that are close-to-ideal waveform shapes. The shapes of targets and/or path portions of the sense coils may be related to how the sense signals generated therein are amplitude modulated as a target disrupts magnetic field between the oscillator coil and the sense coils. As a non-limiting example, as a target rotates above sense coils and disrupts the magnetic field between the oscillator coil and the sense coils, the shape of the target and/or the sense coils may determine the shape of an amplitude-modulation envelope exhibited by the sense signals. As a non-limiting example, an amplitude-modulation envelope of sense signals of sense coils of various examples may be close to a sinusoidal shape. A sinusoidally-shaped amplitude-modulation envelope may be well-suited for translation into an angular position, e.g., through a trigonometric function, e.g., arctangent.

In some traditional sensor design approaches, an inductive angular position sensor provides an angular position measurement over a measurement range of 360 degrees of target rotation with use of a substrate (e.g., PCB) and coil design that spans over the entire 360-degree area of the target. It would be desirable for an inductive angular position sensor to provide an angular position measurement over a full (e.g., 360 degrees) rotation of the target with use of a substrate and coil design that is only a portion of the 360-degree area (e.g., an arc portion, or even only a 180-degree area). Such a design would reduce the size of the substrate and the coils and/or reduce the cost of the sensor.

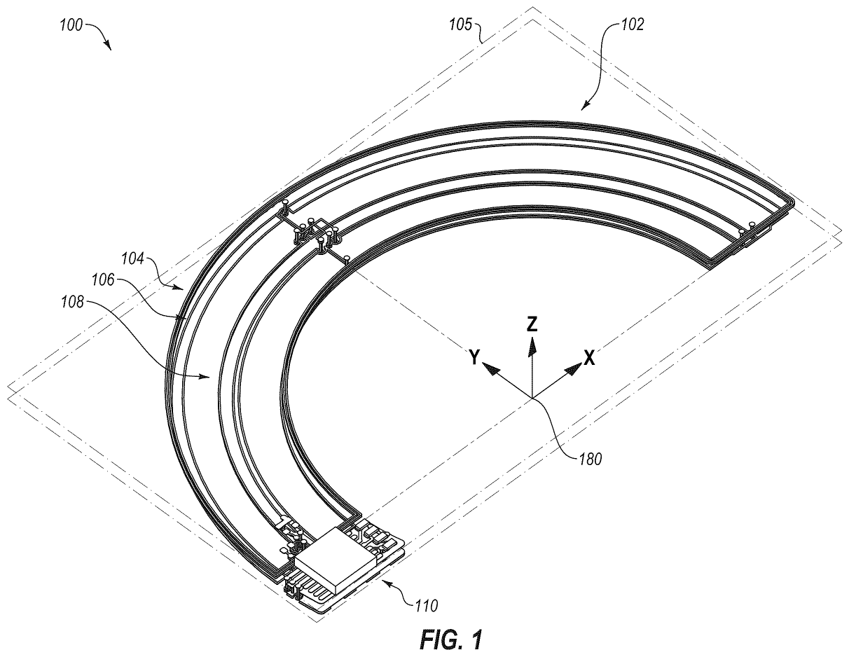

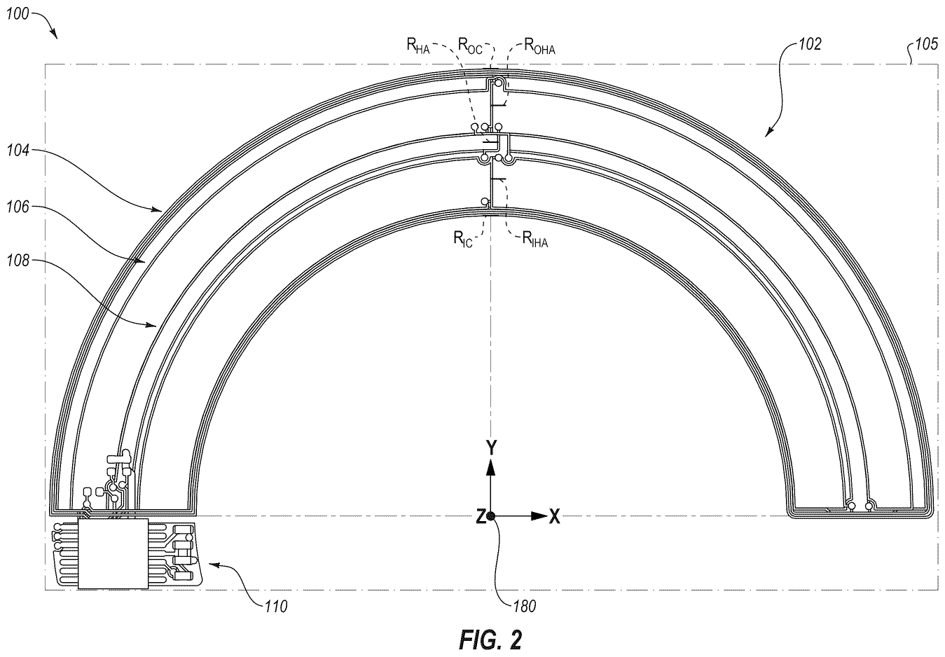

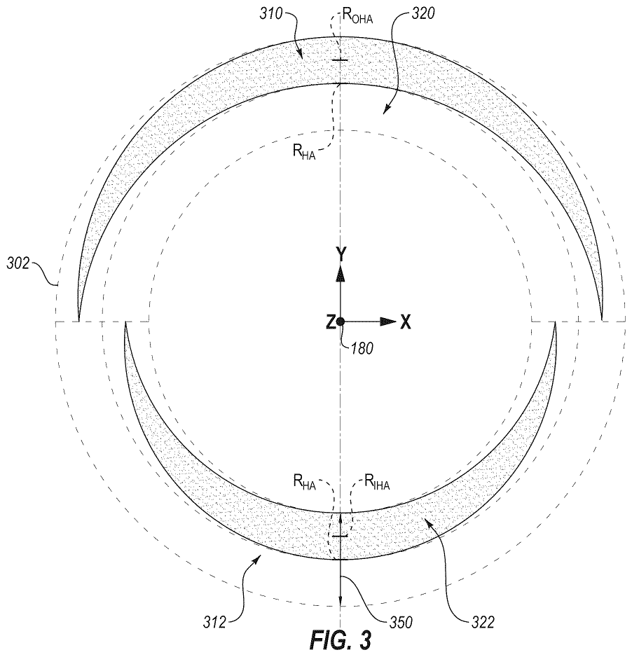

FIG. 1 is a perspective view of an apparatus 100 for inductive angular positioning sensing of a target, according to one or more examples of the disclosure. FIG. 2 is a top-down view of apparatus 100 of FIG. 1. In one or more examples, apparatus 100 of FIGS. 1 and 2 is to sense and/or detect an angular position of a target (e.g., a target 302 of FIG. 3) adapted to rotate about an axis 180. In the figures, axis 180 is indicated as the Z-axis in a three-dimensional co-ordinate axis system (X-Y-Z).

As depicted in FIGS. 1 and 2, apparatus 100 comprises a support structure 105 and a set of coils 102 on, or in, support structure 105. The set of coils 102 include one or more oscillator coils 104, a first sense coil 106, and a second sense coil 108. One or more oscillator coils 104 (e.g., excitation coils) may be referred to as one or more primary coils, and first and second sense coils 106 and 108 may be referred to as secondary coils. A position sensing circuitry 110 is coupled to one or more oscillator coils 104 and first and second sense coils 106 and 108 for inductive angular position sensing of the target.

In one or more examples, apparatus 100 is a planar inductive angular position sensing apparatus where the set of coils 102 are planar coils. Here, support structure 105 may be or include a planar substrate, such as a PCB. Note that axis 180 indicated by the Z-axis is perpendicular to a plane defined by support structure 105 (e.g., an outer surface or one or more other layers thereof). In one or more examples, the set of coils 102 are at least partially formed by or include conductive traces on, and/or in, one or more planes (e.g., multiple planes) of support structure 105. When multiple planes are used for coil arrangements, the multiple planes may be parallel planes at different heights of the substrate. For example, a respective one of the multiple planes may be associated with a different one of multiple layers of the PCB.

In one or more examples, the set of coils 102 are arranged generally in a half annulus centered about axis 180 of rotation for the target. One or more oscillator coils 104 have a coil winding pattern arranged at least generally as a half-circle arc-band-shaped ring indicating boundaries of the half annulus. First sense coil 106 and second sense coil 108 are arranged at least generally in the half annulus and/or surrounded by (at least in substantial part) one or more oscillator coils 104.

In one or more examples, the half annulus of the set of coils 102 may be defined by an outer half circle of an outer circle and an inner half circle of an inner circle defined relative to axis 180. As indicated in FIG. 2, the outer half circle of the half annulus has a radius R_{OC} (i.e., an outer half circle radius R_{OC}) and the inner half circle of the half annulus has a radius R_{IC} (FIG. 2) (i.e., an inner half circle radius R_{IC}), with the radii being defined relative to axis 180. The half annulus has a radius R_{HA} (i.e., a half annulus radius R_{HA}) which may be determined by or based on an average of the outer half circle radius R_{OC} and the inner half circle radius R_{IC}.

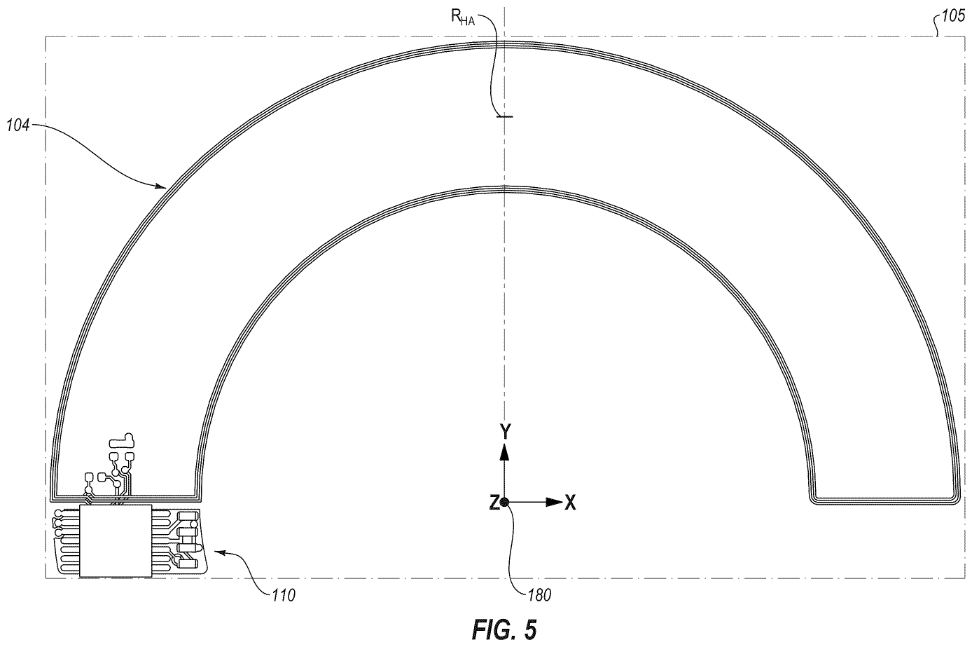

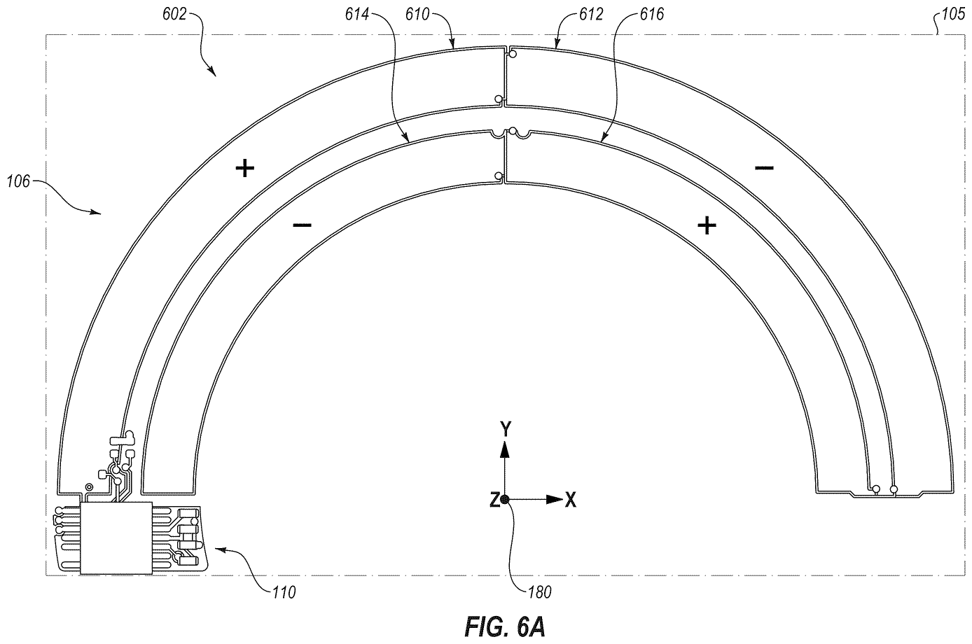

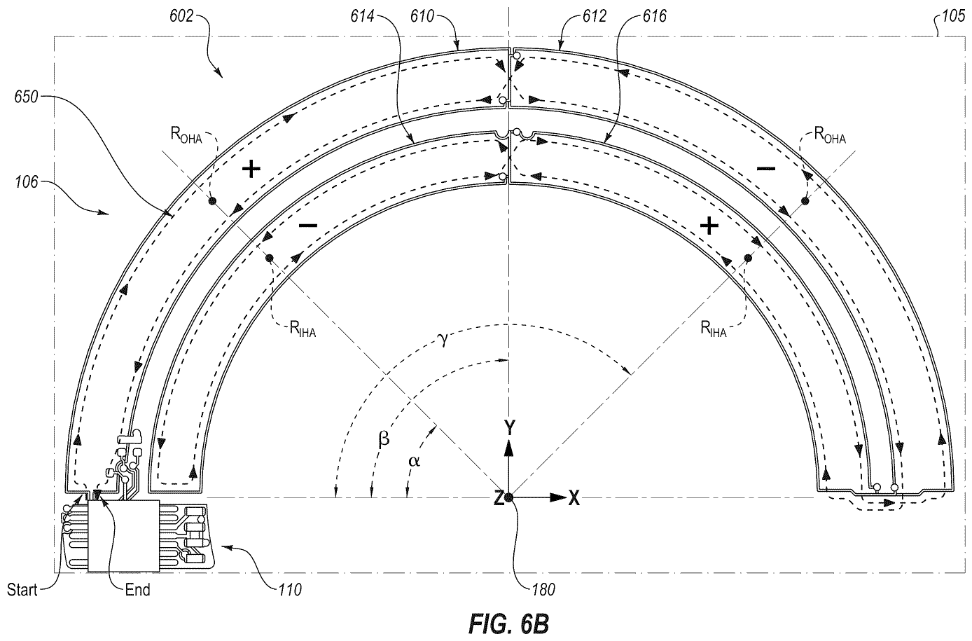

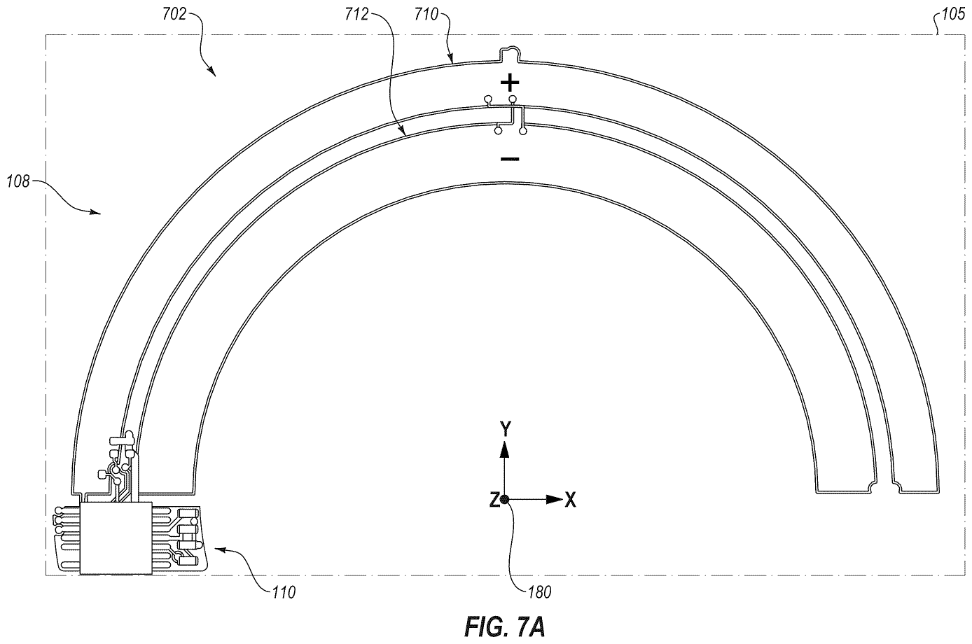

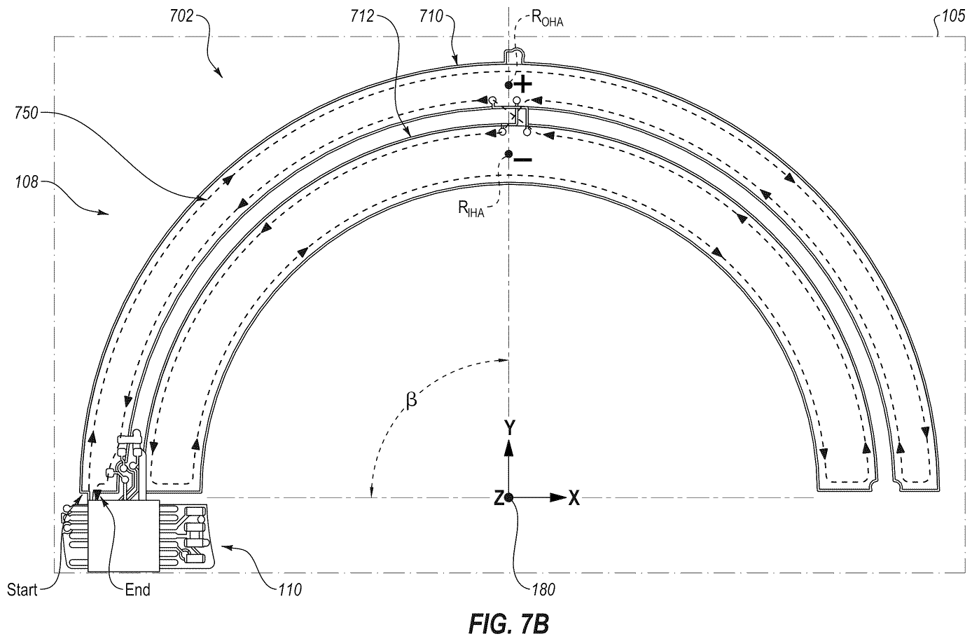

Note that the arrangement of one or more oscillator coils 104 is shown and described in more detail later in relation to FIG. 5, the arrangement of first sense coil 106 is shown and described in more detail later in relation to FIGS. 6A and 6B, and the arrangement of second sense coil 108 is shown and described in more detail later in relation to FIGS. 7A and 7B.

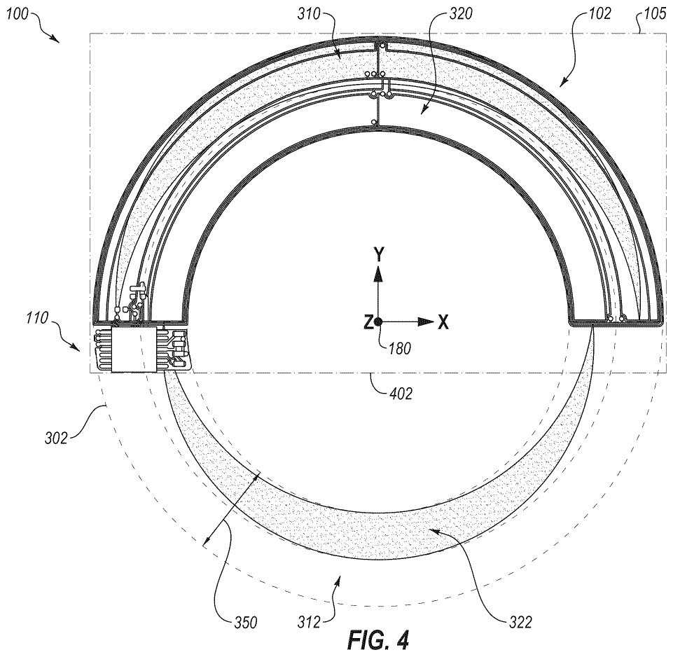

FIG. 3 is a top-down view of a target 302 for use with apparatus of FIGS. 1 and 2, according to one or more examples. FIG. 4 is a top-down view of apparatus 100 of FIGS. 1 and 2 including target 302 of FIG. 3.

Target 302 includes a target body to rotate about axis 180. The target body has a generally planar shape (i.e., in-plane with the page) and, more specifically, a generally planar annular shape. The annular shape of the target body of target 302 may be defined by an outer circle and an inner circle, designated in FIGS. 3 and 4 as an outer dashed circular line and an inner dashed circular line, respectively, at respective arrowhead tips of an arrow line 350. The annular shape of target 302 may substantially match the outer and the inner circles that define the half annulus of the set of coils 102 (FIG. 4).

In one or more examples, the annular shape of the target body includes an outer annulus region and an inner annulus region indicated by the dashed circular lines in FIGS. 3 and 4. More specifically, the outer annulus region of target 302 includes a first outer half annulus region 310 and a second outer half annulus region 312. Second outer half annulus region 312 is opposite first outer half annulus region 310. In addition, the inner annulus region of target 302 includes a first inner half annulus region 320 and a second inner half annulus region 322. Second inner half annulus region 322 is opposite first inner half annulus region 320. Furthermore, first inner half annulus region 320 may be (e.g., directly) adjacent first outer half annulus region 310 (e.g., meeting at the radius R_{HA}), and second inner half annulus region 322 may be (e.g., directly) adjacent second outer half annulus region 312 (e.g., also meeting at the radius R_{HA}).

In one or more examples, the outer annulus region of target 302 has a radius R_{OHA} (e.g., an outer half annulus radius R_{OHA}) that may be generally determined by or based on an average of the outer circle radius (e.g., R_{OC} of FIG. 2) and the radius R_{HA}. In addition, the inner annulus region of target 302 has a radius R_{IHA} (e.g., an inner half annulus radius R_{IHA}) that may be generally determined by or based on an average of the inner circle radius (e.g., R_{IC} of FIG. 2) and the radius R_{HA}.

In one or more examples, at least a substantial portion of first outer half annulus region 310 comprises conductive material. In one or more examples, second outer half annulus region 312 comprises non-conductive material (e.g., dielectric material). On the other hand, in one or more examples, at least a substantial portion of second inner half annulus region 322 comprises conductive material. In one or more examples, first inner half annulus region 320 comprises non-conductive material (e.g., dielectric material). In one or more examples, an inner (central) circular region of target 302 may be without any target material (e.g., void of any materials) (e.g., for through-shaft insertion of a through-shaft).

In one or more examples, the conductive material of the target body of target 302 may be or include a non-magnetic conductive metal or metal alloy, without limitation. In one or more examples, the non-magnetic conductive metal or metal alloy may be or include copper or aluminum, without limitation. In one or more other examples, the target body of target 302 may be made of a magnetic conductive metal or metal alloy, such as carbon steel or ferritic stainless steel, without limitation. For example, an oscillator may generate an excitation signal within a certain range of frequencies that the magnetic domains of the magnetic conductive metals or metal alloys will not react to.

In at least some contexts, respective ones of the at least substantial portions of first outer half annulus region 310 and second inner half annulus region 322 comprising the conductive material may be referred to as conductive metal structures. On the other hand, the non-conductive portions may be referred to as dielectric structures.

In one or more examples, the respective ones of the at least substantial portions of first outer half annulus region 310 and second inner half annulus region 322 comprising the conductive material define a crescent shape (e.g., as a “crescent-shaped structure”), as depicted in FIG. 3. Here, respective regions outside of the respective crescent shapes in first outer half annulus region 310 and second inner half annulus region 322 comprise non-conductive material. In one or more specific examples, the crescent-shaped structure is a substantially “waning crescent moon” shaped structure or a substantially “waxing crescent moon” shaped structure.

In one or more alternative examples, substantially the entirety of first outer half annulus region 310 comprises conductive material (i.e., substantially the entirety of first outer half annulus region 310 is or includes a conductive metal structure), and substantially the entirety of second inner half annulus region 322 comprises conductive material (i.e., substantially the entirety of second inner half annulus region 322 is or includes a conductive metal structure).

In one or more examples of FIGS. 1, 2, and 4, support structure 105 is a generally planar rectangular structure (e.g., a generally planar rectangular PCB). As depicted in FIG. 4, an edge 402 of support structure 105 is indicated illustrate an example length, size, and/or area of support structure 105 and/or set of coils 102 relative to an example length, size, and/or area of target 302. In one or more examples, the length, the size, and/or the area of support structure 105 is substantially less than the length, the size, and/or the area of target 302. In one or more alternative examples, support structure 105 is a generally planar half annular structure, which may generally be sized to fit (or be slightly larger than) the half annulus of the set of coils 102. In a specific, non-limiting example, the generally planar half annular structure of support structure 105 is sized to fit or otherwise accommodate the half annulus of the set of coils 102 as well as position sensing circuitry 110.

In a specific, non-limiting example, target 302 may be connected to a through-shaft which may extend through support structure 105 (e.g., a through-hole of apparatus 100 may have a relatively large radius to accommodate the through-shaft).

General contemplated operation is now described. When apparatus 100 is in operational use, target 302 (FIG. 4) rotates around axis 180. In general, target 302 disrupts magnetic coupling between one or more oscillator coils 104 and first and second sense coils 106 and 108 (FIGS. 1 and 2), such that sense signals induced in first and second sense coils 106 and 108 are indicative of an angular position of target 302 as it rotates around axis 180. The degree to which target 302 disrupts magnetic coupling between one or more oscillator coils 102 and first and second sense coils 106 and 108 may vary at least partially in response to changes in the angular position of target 302.

For angular position sensing of target 302, apparatus 100 includes position sensing circuitry 110. In one or more examples, position sensing circuitry 110 may be or include a sensor IC. During contemplated operation, position sensing circuitry 110 generates a high frequency signal to excite one or more oscillator coils 104 to produce an alternating magnetic field. The magnetic field couples onto first and second sense coils 106 and 108 for generating voltage signals (e.g., first and second sense signals, respectively). As target 302 disturbs the generated magnetic field, first and second sense coils 106 and 108 receives modulated voltage signals according to the angular position of target 302. That is, when target 302 is present and rotating, it creates modulated first and second sense signals provided as feedback signals to position sensing circuitry 110 (e.g., the IC). Internal to the sensor IC, the signals are demodulated to produce demodulated first and second position signals. Position information may be calculated (e.g., in a microcontroller unit or CPU of the sensor IC), for example, by taking an arctan 2 function of the ratio of the two demodulated position signals.

In one or more examples, apparatus 100 is a one (1) pole pair sensor that provides an angular position measurement over a measurement range of 360 degrees. In a specific, non-limiting example, apparatus 100 is a side-shaft inductive angular position sensor having an absolute 360° measurement range.

FIG. 5 is a top-down view of one or more oscillator coils 104 of the set of coils of the apparatus of FIGS. 1-4, according to one or more examples, where the first sense coil and the second sense coil are removed and separated from support structure 105 for illustrative clarity.

As illustrated in FIG. 5, one or more oscillator coils 104 have a coil winding pattern arranged at least generally as a half-circle arc-band-shaped ring. The half-circle arc-band-shaped ring of one or more oscillator coils 104 indicates boundaries of the half annulus in which the remaining coils are generally arranged. In one or more examples, the coil winding pattern of one or more oscillator coils 104 may be arranged at least generally along or around boundaries of the half annulus. The coil winding pattern of one or more oscillator coils 104 may provide a half annular-shaped path (e.g., a continuous path) for electrical current to flow. The radius R_{HA} (or the half annulus radius R_{HA}) of the half annulus of the coil winding pattern of one or more oscillator coils 104 is indicated in FIG. 5, also considered herein to be a center or center-point of the half-circle arc-band-shaped ring.

In one or more specific examples, one or more oscillator coils 104 include first and second oscillator coils coupled at a common center tap. Here, an excitation circuitry generates first and second excitation signals in the first and the second oscillator coils, respectively, to produce the varying magnetic field which induces the sense signals in the sense coils. In one or more examples, the second excitation signal is substantially 180 degrees out-of-phase with the first excitation signal.

FIG. 6A is a top-down view of first sense coil 106 of the set of coils of the apparatus of FIGS. 1-4, according to one or more examples, where the one or more oscillator coils and the second sense coil are removed and separated from support structure 105 for illustrative clarity.

As illustrated in FIG. 6A, first sense coil 106 has a coil winding pattern including multiple lobes 602 (e.g., a number of first lobes). In one or more examples, multiple lobes 602 include lobes 610, 612, 614, and 616. Respective lobes of lobes 610, 612, 614, and 616 are arranged at least generally as quarter-circle arc-band-shaped rings in respective quarter annulus regions of the half annulus.

In one or more examples as shown, lobes 610, 612, 614, and 616 of first sense coil 106 arranged as the quarter-circle arc-band-shaped rings in the respective quarter annulus regions are substantially proportionally arranged in the half annulus including outer and inner half annulus regions thereof. In one or more specific examples, lobe 610 is arranged at least generally at an outer left quarter annulus region of the half annulus, lobe 612 is arranged at least generally at an outer right quarter annulus region of the half annulus, lobe 614 is arranged at least generally at an inner left quarter annulus region of the half annulus, and lobe 616 is arranged at least generally at an inner right quarter annulus region of the half annulus.

In one or more examples, respective lobes of lobes 610 and 616 of first sense coil 106 are positive lobes (e.g., clockwise flows) (indicated with “+” in FIG. 6A), and respective lobes of lobes 612 and 614 of first sense coil 106 are negative lobes (e.g., counter-clockwise flows) (indicated with “−” in FIG. 6A). More generally, respective lobes of lobes 610 and 616 of first sense coil 106 may be one of positive lobes or negative lobes, and respective lobes of lobes 612 and 614 of first sense coil 106 may be the other one of positive lobes or negative lobes.

FIG. 6B is a top-down view of first sense coil 106 of the set of coils shown in FIG. 6A, and further indicating a continuous path 650 of the coil winding, according to one or more examples.

Continuous path 650 of first sense coil 106 defines a number of first lobes including lobes 610, 612, 614, and 616. In the specific, non-limiting example shown in FIG. 6B, lobe 610 arranged as a quarter-circle arc-band-shaped ring may have a center or center-point defined herein at the radius R_{OHA} and an angle α relative to the X-axis as indicated, where α=45 degrees; lobe 612 arranged as a quarter-circle arc-band-shaped ring may have a center or center-point defined herein at the radius R_{OHA} and an angle γ relative to the X-axis as indicated, where α=135 degrees; lobe 614 arranged as a quarter-circle arc-band-shaped ring may have a center or center-point defined herein at the radius R_{IHA} and the angle α; and lobe 616 arranged as a quarter-circle arc-band-shaped ring may have a center or center-point defined herein at the radius R_{IHA} and the angle γ.

Continuous path 650 of first sense coil 106 is indicated in FIG. 6B as a dotted line with arrows indicating the direction of the path, where path connections are made from layer to layer of the support structure through electrically conductive vias (e.g., indicated as small circular structures in the figures). Continuous path 650 may indicate an example electrical current flow of the coil winding from start and end points of position sensing circuitry 110 indicated in FIG. 6B.

Beginning at the “start” point of FIG. 6B, continuous path 650 extends along an upper winding portion of lobe 610 clockwise from left/bottom to middle/top, connecting to a lower winding portion of lobe 612 clockwise from middle/top to right/bottom, connecting to a lower winding portion of lobe 616 counter-clockwise from right/bottom to middle/top, connecting to an upper winding portion of lobe 614 counter-clockwise from middle/top to left/bottom, around to a lower winding portion of lobe 614 clockwise from left/bottom to middle/top, connecting to an upper winding portion of lobe 616 clockwise from middle/top to right/bottom, connecting to an upper winding portion of lobe 612 counter-clockwise from right/bottom to middle/top, and connecting to a lower winding portion of lobe 610 counter-clockwise from middle/top to left/bottom, to the “end” point.

FIG. 7A is a top-down view of second sense coil 108 of the set of coils of the apparatus of FIGS. 1-4, where the one or more oscillator coils and the first sense coil are removed and separated from support structure 105 for illustrative clarity, according to one or more examples.

As illustrated in FIG. 7A, second sense coil 108 has a coil winding pattern including multiple lobes 702 (e.g., a number of second lobes, which is less than the number of first lobes of the first sense coil of FIG. 6A in one or more examples). In one or more examples, multiple lobes 702 include lobes 710 and 712. Respective ones of lobes 710 and 712 are arranged at least generally as half-circle arc-band-shaped rings in respective outer and inner half annuluses of the half annulus.

In one or more examples as shown, fifth and sixth lobes 710 and 712 of second sense coil 108 arranged at least generally as the half-circle arc-band-shaped rings in the respective outer and inner annular regions are substantially proportionally arranged in the half annulus including the outer and the inner half annulus regions thereof. In one or more examples, lobe 710 is at an outer half annulus region of the half annulus, and lobe 712 is at an inner half annulus region of the half annulus.

In one or more examples, lobe 710 of FIG. 7A is generally coextensive with lobes 610 and 612 (FIG. 6A) in the outer half annulus region of the half annulus, and lobe 712 of FIG. 7A is generally coextensive with lobes 614 and 616 (FIG. 6A) in the inner half annulus region of the half annulus.

In one or more examples, lobe 710 is a positive lobe (e.g., clockwise flow) (indicated with “+” in FIG. 7A), and lobe 712 is a negative lobe (e.g., counter-clockwise flow) (indicated with “−” in FIG. 7A). More generally, lobe 710 is one of a positive lobe or a negative lobe, and lobe 712 of is the other one of the positive lobe or the negative lobe.

FIG. 7B is a top-down view of second sense coil 108 of the set of coils shown in FIG. 7A, further indicating a continuous path 750 of the coil winding, according to one or more examples.

Continuous path 750 defines a number of second lobes including lobes 710 and 712. In one or more examples, the number of second lobes of second sense coil 108 is less than the number of first lobes of the first sense coil (e.g., FIGS. 6A and 6B). In the specific, non-limiting example shown in FIG. 7B, lobe 710 arranged as an half-circle arc-band-shaped ring has a center or center-point defined herein at the radius R_{OHA} and an angle β relative to the X-axis as indicated, where β=90 degrees; and lobe 712 arranged as an half-circle arc-band-shaped ring has a center or center-point defined herein at the radius R_{IHA} and the angle β.

Continuous path 750 of second sense coil 108 is indicated in FIG. 7B as a dotted line with arrows indicating the direction of the path, where path connections are made from layer to layer of the support structure through electrically conductive vias (e.g., indicated as small circular structures in the figures). Continuous path 750 may indicate an example electrical current flow of the coil winding from start and end points of position sensing circuitry 110 indicated in FIG. 7B.

Beginning at the “start” point of FIG. 7B, continuous path 750 extends along an upper winding portion of lobe 710 clockwise from left/bottom to right/bottom, around to a lower winding portion of lobe 710 counter-clockwise from right/bottom to middle/top, connecting to an upper winding portion of lobe 712 counter-clockwise from middle/top to left/bottom, around to a lower winding portion of lobe 712 clockwise from left/bottom to right/bottom, around to an upper winding portion of lobe 712 counter-clockwise from right/bottom to middle/top, connecting to a lower winding portion of lobe 710 counter-clockwise from middle/top to left/bottom, to the “end” point.

In a specific-non-limiting example, the set of coils 102 of apparatus 100 are laid out as conductive traces in a four (4) layered PCB. In this specific example, one or more oscillator coils 104 are formed or otherwise provided in layer one (L1) and layer two (L2) of the PCB, first sense coil 106 is formed or otherwise provided in layer three (L3) and layer four (L4) of the PCB, and second sense coil 108 is also formed or otherwise provided in layer three (L3) and layer four (L4) of the PCB.

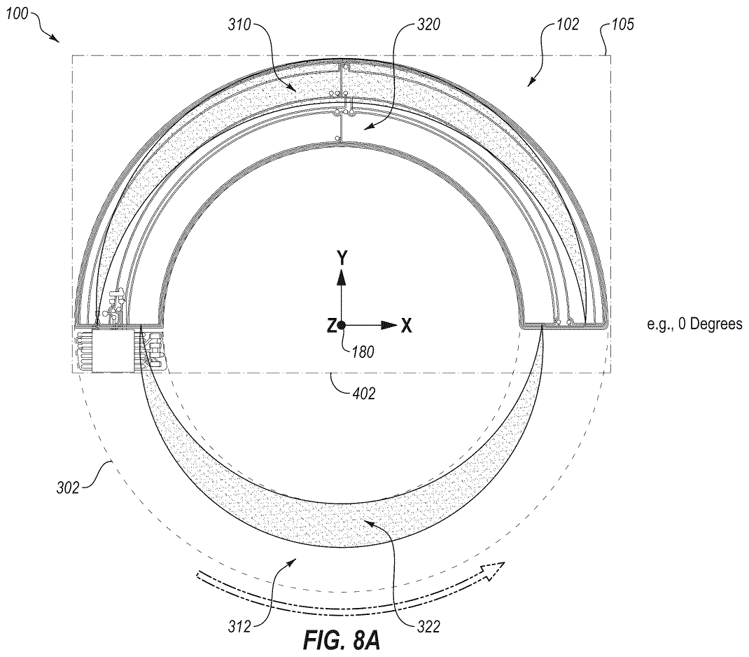

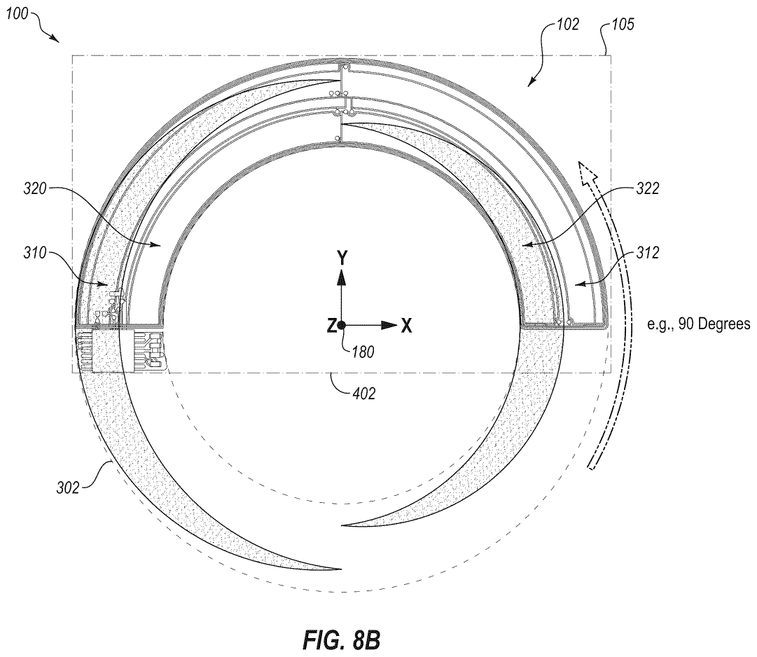

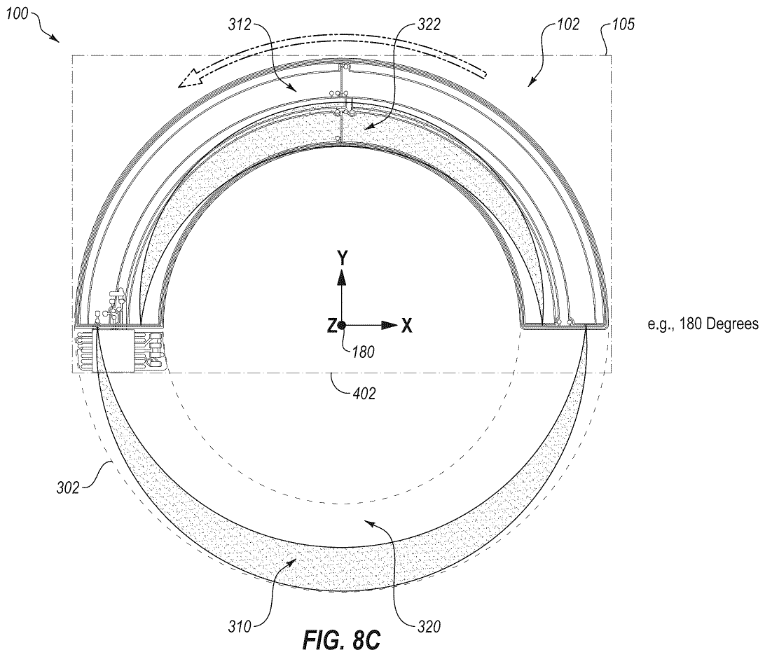

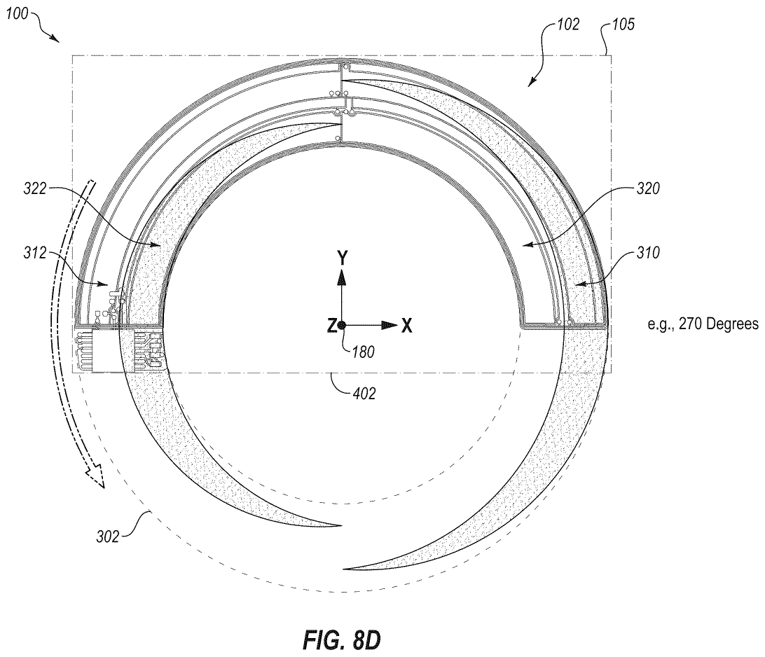

FIGS. 8A, 8B, 8C, and 8D are respective top-down views of apparatus 100 for inductive angular position sensing of target 302 rotated at different angular positions about axis 180, according to one or more examples. In these figures, edge 402 of support structure 105 is again indicated to illustrate an example length, size, and/or area of support structure 105 and set of coils 102 relative to an example length, size, and/or area of target 302. In one or more alternative examples, support structure 105 has a generally half annular shape that is sized to fit the half annulus of the set of coils 102.

In FIG. 8A, target 302 is rotated at a first angular position (e.g., a 0-degree rotation) according to one or more examples. In the first angular position, the conductive metal structure of first outer half annulus region 310 of target 302 is (e.g., fully) adjacent and/or over at least some of the set of coils 102 (e.g., adjacent and/or over lobes 610 and 612 of first sense coil 106 of FIGS. 6A and 6B and lobe 710 of second sense coil 108 of FIGS. 7A and 7B), and the conductive metal structure of second inner half annulus region 322 of target 302 is (e.g., fully) nonadjacent and/or extending outside of the set of coils 102 (e.g., nonadjacent and/or extending outside of one or more oscillator coils 104 of FIG. 5, first sense coil 106 of FIGS. 6A and 6B, and second sense coil 108 of FIGS. 7A and 7B). On the other hand, the dielectric structure of first inner half annulus region 320 of target 302 is (e.g., fully) adjacent and/or over at least some of the set of coils 102 (e.g., adjacent and/or over lobes 614 and 616 of first sense coil 106 of FIGS. 6A and 6B and lobe 712 of second sense coil 108 of FIGS. 7A and 7B), and the dielectric structure of second outer half annulus region 312 of target 302 is (e.g., fully) nonadjacent and/or extending outside of the set of coils 102 (e.g., nonadjacent and/or extending outside of one or more oscillator coils 104 of FIG. 5, first sense coil 106 of FIGS. 6A and 6B, and second sense coil 108 of FIGS. 7A and 7B).

In FIG. 8B, target 302 is rotated further at a second angular position (e.g., a 90-degree rotation) according to one or more examples. In the second angular position, (e.g., only) a first part of (e.g., about half of) the conductive metal structure of first outer half annulus region 310 of target 302 is adjacent and/or over at least some of the set of coils 102 (e.g., only about half of the conductive metal structure is adjacent and/or over lobe 610 of first sense coil 106 of FIGS. 6A and 6B and adjacent and/or over about half of lobe 710 of second sense coil 108 of FIGS. 7A and 7B); and (e.g., only) a second part (e.g., about the other half of) the conductive metal structure of first outer half annulus region 310 of target 302 is nonadjacent and/or extending outside of the set of coils 102 (e.g., nonadjacent and/or extending outside of one or more oscillator coils 104 of FIG. 5, first sense coil 106 of FIGS. 6A and 6B, and second sense coil 108 of FIGS. 7A and 7B). In addition, (e.g., only) a first part of (e.g., about half of) the conductive metal structure of second inner half annulus region 322 of target 302 is adjacent and/or over at least some of the set of coils 102 (e.g., only about half of the conductive metal structure is adjacent and/or over lobe 616 of first sense coil 106 of FIGS. 6A and 6B and adjacent and/or over about half of lobe 712 of second sense coil 108 of FIGS. 7A and 7B); and (e.g., only) a second part (e.g., about the other half of) the conductive metal structure of second inner half annulus region 322 of target 302 is nonadjacent and/or extending outside of the set of coils 102 (e.g., nonadjacent and/or extending outside of one or more oscillator coils 104 of FIG. 5, first sense coil 106 of FIGS. 6A and 6B, and second sense coil 108 of FIGS. 7A and 7B).

On the other hand, (e.g., only) a first part of (e.g., about half of) the dielectric structure of first inner half annulus region 320 of target 302 is adjacent and/or over at least some of the set of coils 102 (e.g., only about half of the dielectric structure is adjacent and/or over lobe 614 of first sense coil 106 of FIGS. 6A and 6B and adjacent and/or over about half of lobe 712 of second sense coil 108 of FIGS. 7A and 7B); and (e.g., only) a second part of (e.g., about the other half of) the dielectric structure of first inner half annulus region 320 of target 302 is nonadjacent and/or extending outside of the set of coils 102 (e.g., nonadjacent and/or extending outside of one or more oscillator coils 104 of FIG. 5, first sense coil 106 of FIGS. 6A and 6B, and second sense coil 108 of FIGS. 7A and 7B). In addition, (e.g., only) a first part of (e.g., about half of) the dielectric structure of second outer half annulus region 312 of target 302 is adjacent and/or over at least some of the set of coils 102 (e.g., only about half of the dielectric structure is adjacent and/or over lobe 612 of first sense coil 106 of FIGS. 6A and 6B and adjacent and/or over about half of lobe 710 of second sense coil 108 of FIGS. 7A and 7B); and (e.g., only) a second part of (e.g., about the other half of) the dielectric structure of second outer half annulus region 312 of target 302 is nonadjacent and/or extending outside of the set of coils 102 (e.g., only about half of the dielectric structure is non-adjacent and/or extending outside of one or more oscillator coils 104 of FIG. 5, first sense coil 106 of FIGS. 6A and 6B, and second sense coil 108 of FIGS. 7A and 7B).

In FIG. 8C, target 302 is rotated even further at a third angular position (e.g., a 180-degree rotation) according to one or more examples. In the third angular position, the conductive metal structure of first outer half annulus region 310 of target 302 is (e.g., fully) nonadjacent and/or extending outside of the set of coils 102 (e.g., nonadjacent and/or extending outside of one or more oscillator coils 104 of FIG. 5, first sense coil 106 of FIGS. 6A and 6B, and second sense coil 108 of FIGS. 7A and 7B; and the conductive metal structure of second inner half annulus region 322 of target 302 is (e.g., fully) adjacent and/or over at least some of the set of coils 102 (e.g., adjacent and/or over lobes 614 and 616 of first sense coil 106 of FIGS. 6A and 6B and lobe 712 of second sense coil 108 of FIGS. 7A and 7B). On the other hand, the dielectric structure of first inner half annulus region 320 of target 302 is (e.g., fully) nonadjacent and/or extending outside of the set of coils 102 (e.g., nonadjacent and/or extending outside of one or more oscillator coils 104 of FIG. 5, first sense coil 106 of FIGS. 6A and 6B, and second sense coil 108 of FIGS. 7A and 7B); and the dielectric structure of second outer half annulus region 312 of target 302 is (e.g., fully) adjacent and/or over at least some of the set of coils 102 (e.g., adjacent and/or over lobes 610 and 612 of first sense coil 106 of FIGS. 6A and 6B and lobe 710 of second sense coil 108 of FIGS. 7A and 7B).

In FIG. 8D, target 302 is rotated yet further at a fourth angular position (e.g., a 270-degree rotation) according to one or more examples. In the fourth angular position, (e.g., only) a first part of (e.g., about half of) the conductive metal structure of first outer half annulus region 310 of target 302 is adjacent and/or over at least some of the set of coils 102 (e.g., only about half of the metal structure is adjacent and/or over lobe 612 of first sense coil 106 of FIGS. 6A and 6B and adjacent and/or over about half of lobe 710 of second sense coil 108 of FIGS. 7A and 7B); and (e.g., only) a second part (e.g., about the other half of) the conductive metal structure of first outer half annulus region 310 of target 302 is nonadjacent and/or extending outside of the set of coils 102 (e.g., nonadjacent and/or extending outside of one or more oscillator coils 104 of FIG. 5, first sense coil 106 of FIGS. 6A and 6B, and second sense coil 108 of FIGS. 7A and 7B). In addition, (e.g., only) a first part of (e.g., about half of) the conductive metal structure of second inner half annulus region 322 of target 302 is adjacent and/or over at least some of the set of coils 102 (e.g., only about half of the conductive metal structure is adjacent and/or over lobe 614 of first sense coil 106 of FIGS. 6A and 6B and adjacent and/or over about half of lobe 712 of second sense coil 108 of FIGS. 7A and 7B); and (e.g., only) a second part (e.g., about the other half of) the conductive metal structure of second inner half annulus region 322 of target 302 is nonadjacent and/or extending outside of the set of coils 102 (e.g., nonadjacent and/or extending outside of one or more oscillator coils 104 of FIG. 5, first sense coil 106 of FIGS. 6A and 6B, and second sense coil 108 of FIGS. 7A and 7B).

On the other hand, (e.g., only) a first part of (e.g., about half of) the dielectric structure of first inner half annulus region 320 of target 302 is adjacent and/or over at least some of the set of coils 102 (e.g., only about half of the dielectric structure is adjacent and/or over lobe 616 of first sense coil 106 of FIGS. 6A and 6B and adjacent and/or over about half of lobe 712 of second sense coil 108 of FIGS. 7A and 7B); and (e.g., only) a second part of (e.g., about the other half of) the dielectric structure of first inner half annulus region 320 of target 302 is nonadjacent and/or extending outside of the set of coils 102 (e.g., nonadjacent and/or extending outside of one or more oscillator coils 104 of FIG. 5, first sense coil 106 of FIGS. 6A and 6B, and second sense coil 108 of FIGS. 7A and 7B). In addition, (e.g., only) a first part of (e.g., about half of) the dielectric structure of second outer half annulus region 312 of target 302 is adjacent and/or over at least some of the set of coils 102 (e.g., only about half of the dielectric structure is adjacent and/or over lobe 610 of first sense coil 106 of FIGS. 6A and 6B and adjacent and/or over about half of lobe 710 of second sense coil 108 of FIGS. 7A and 7B); and (e.g., only) a second part of (e.g., about the other half of) the dielectric structure of second outer half annulus region 312 of target 302 is non-adjacent and/or extending outside of the set of coils 102 (e.g., only about half of the dielectric structure is nonadjacent and/or extending outside of one or more oscillator coils 104 of FIG. 5, first sense coil 106 of FIGS. 6A and 6B, and second sense coil 108 of FIGS. 7A and 7B).

Note that a full, 360-degree rotation of target 302 will match the first angular position of target 302 shown and described in relation to FIG. 8A.

As shown and described herein, each sensor winding or lobe is generally trapezoidal or defines a generally trapezoidal-shaped ring (e.g., as arc-band-shaped rings in FIGS. 6A and 7A). Therefore, respective conductive portions of target 302 are formed with crescent shapes (FIGS. 3, 8A, 8B, 8C, and 8D) so that the area of target 302 covering over the respective lobes is sinusoidal to maintain good accuracy. In one or more alternative examples, respective conductive portions of target 302 are formed to have crescent shape variations, or shapes other than crescent shapes, for a reduced but acceptable accuracy. In one or more alternative examples, each sensor winding or lobe is generally sinusoidal or crescent-shaped (e.g., as crescent-shaped rings) and respective conductive portions of target 302 are generally trapezoidal-shaped or arc-band-shaped. Other variations on the shapes of the sensor windings or lobes and the conductive portions of the target may also be realized, as one skilled in the art will readily appreciate.

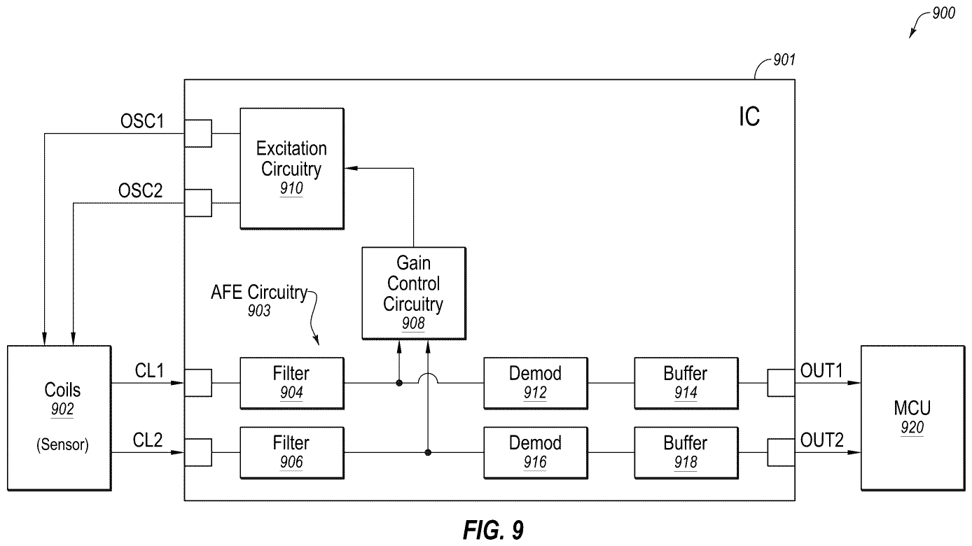

FIG. 9 is a schematic diagram of a position sensing circuitry 900 of an apparatus comprising an inductive angular position sensor, according to one or more examples. Position sensing circuitry 900 of FIG. 9 may be position sensing circuitry 110 of apparatus 100 of FIGS. 1 and 2. In one or more examples, position sensing circuitry 900 may be contained (in total or in part) in an IC 901 (e.g., a sensor IC). In FIG. 9, coils 902 (“Sensor”) may represent the set of coils 102 of FIG. 1, which include one or more oscillator coils 102 (FIG. 5), first sense oscillator coil 104 (FIGS. 6A and 6B), and second sense coil 106 (FIGS. 7A and 7B).

In one or more examples, position sensing circuitry 900 includes an excitation circuitry 910, an analog front-end (AFE) circuitry 903, and a gain control circuitry 908. AFE circuitry 903 may also include, for a modulated first sense signal from the first sense coil (e.g., at a CL1 input), a filter 904 (e.g., an EMI filter), a demodulator 912, and a buffer circuit 914. AFE circuitry 903 may also include, for a modulated second sense signal from the second coil (e.g., at a CL2 input), a filter 906 (e.g., an EMI filter), a demodulator 916, and a buffer circuit 918. Gain control circuitry 908 is used to adjust the signal gain of excitation circuitry 910 based at least on the received/modulated first and second sense signals. Demodulated first and second position signals (e.g., indicating a position of the target) may be provided at OUT1 and OUT2 outputs of position sensing circuitry 900 after passing through buffer circuits 914 and 918, respectively.

Contemplated operation of the sensor/circuitry will be described. In general, demodulated first and second position signals (e.g., indicating an angular position of the target) are determined at least partially based on the modulated first and second sense signals from the first and the second sense coils (e.g., from the CL1 and CL2 inputs), respectively. More specifically, excitation circuitry 910 generates one or more excitation signals (e.g., at the OSC1 and OSC2 outputs of IC 901) in the one or more oscillator coils to produce a varying magnetic field to induce the first and second sense signals in the first and second sense coils, respectively. The varying magnetic field may be disturbed in accordance with an angular position of the target (e.g., target 302 of FIG. 3) which modulates the first and second sense signals. At IC 901, the modulated first and second sense signals are received from the first and second sense coils at its inputs (e.g., the CL1 and CL2 inputs). AFE circuitry 903 receives and processes the modulated first and second sense signals. More specifically, the modulated first sense signal (at the CL1 input) is filtered through filter 904, demodulated by demodulator 912 to produce the demodulated first position signal, and sent to the OUT1 output through buffer circuit 914. The modulated second sense signal (at the CL2 input) is filtered through filter 906, demodulated by demodulator 916 to produce the demodulated second position signal, which is sent to the OUT2 output through buffer circuit 918.

In one or more examples, when position sensing circuitry 900 includes a processor (e.g., a central processing unit (CPU)), position sensing circuitry 900 may calculate the angular position of the target at least partially based on the demodulated first and second position signals (e.g., based on the arctan 2 function, without limitation). In one or more other examples, a microcontroller unit (MCU) 920 or an electronic control unit (ECU) may receive the first and second position signals at the OUT1 and OUT 2 outputs, respectively, and calculate the angular position of the target at least partially based on the demodulated first and second position signals (e.g., based on the arctan 2 function, without limitation).

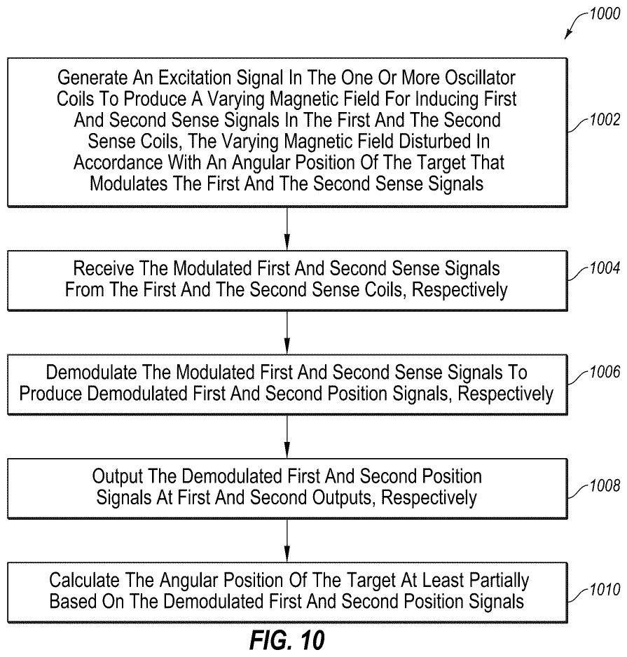

FIG. 10 is a flowchart describing a method 1000 of operation of an apparatus for inductive angular position sensing, according to one or more examples. In one or more examples, method 1000 may be performed with use of apparatus 100 associated with FIGS. 1, 2, 3, 4, 5, 6A, 6B, 7A, 7B, 8A-8D, and 9.

At an act 1002, an excitation signal in the one or more oscillator coils is generated to produce a varying magnetic field to induce first and second sense signals in the first and the second sense coils, respectively. The varying magnetic field may be disturbed in accordance with the angular position of the target which modulates the first and second sense signals to produce modulated first and second sense signals. At an act 1004, the modulated first and second sense signals are received from the first and the second sense coils, respectively. At an act 1006, the modulated first and second sense signals are demodulated to produce demodulated first and second position signals, respectively. In one or more examples, the demodulated first and second position signals may be first and second voltage position signals, which may be differential signals. At an act 1008, the demodulated first and second position signals are output at first and second outputs, respectively. At an act 1010, the angular position of the target may be calculated at least partially based on the demodulated first and second position signals. In one or more examples, the angular position of the target may be calculated at least partially based on an arctan 2 function (e.g., by taking an arctan 2 function of the ratio of the two sense signals).

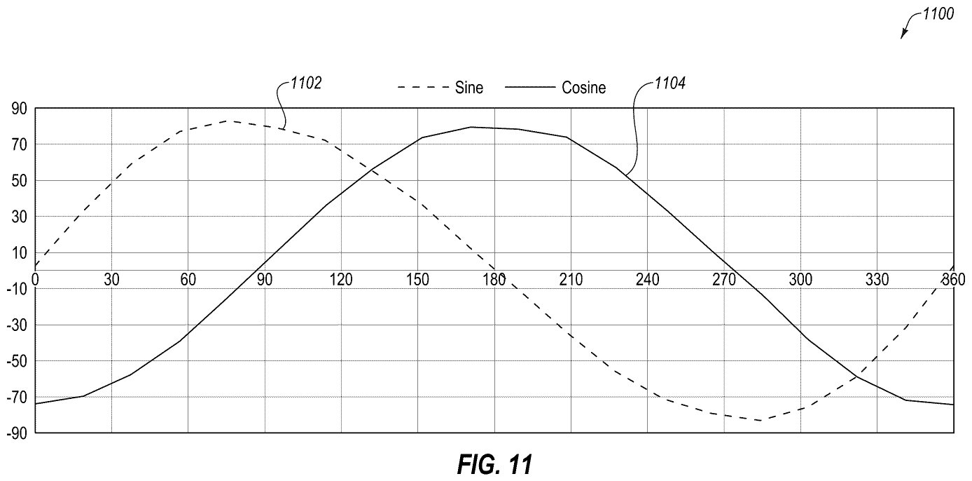

FIG. 11 is a graph 1100 of example demodulated output waveforms of an inductive angular position sensing apparatus, according to one or more examples. The demodulated output waveforms may be signals generated by apparatus 100 of FIGS. 1, 2, 3, 4, 5, 6A, 6B, 7A, 7B, 8A-8D, 9, and 10. More particularly, graph 1100 indicates a demodulated first position signal 1102 and a demodulated second position signal 1104 of the inductive angular position sensing apparatus. In FIG. 11, demodulated first and second position signals 1102 and 1104 are sinusoidal signals that are 90° out-of-phase with each other. As depicted in FIG. 11, respective ones of demodulated first and second position signals 1102 and 1104 exhibit one (1) cycle for every full or 360-degree rotation of the target.

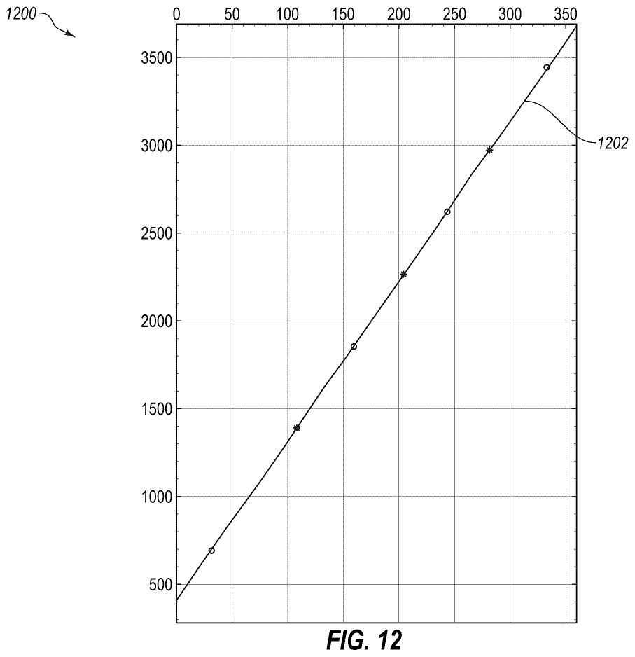

FIG. 12 is a plot 1200 of an example of a detected angular position 1202 of a target of an apparatus for inductive angular position sensing, according to one or more examples. In FIG. 12, detected angular position 1202 is provided in the form of a position voltage as a function of target angular position (from 0 to 360 degrees). Detected angular position 1202 may be determined at least partially based on demodulated output waveforms of an inductive angular position sensor (e.g., demodulated first and second sense signals 1102 and 1104 of FIG. 11) (e.g., based on an arctan 2 function thereof). Detected angular position 1202 of FIG. 12 indicates an angular position of the target over a full or 360-degree target rotation.

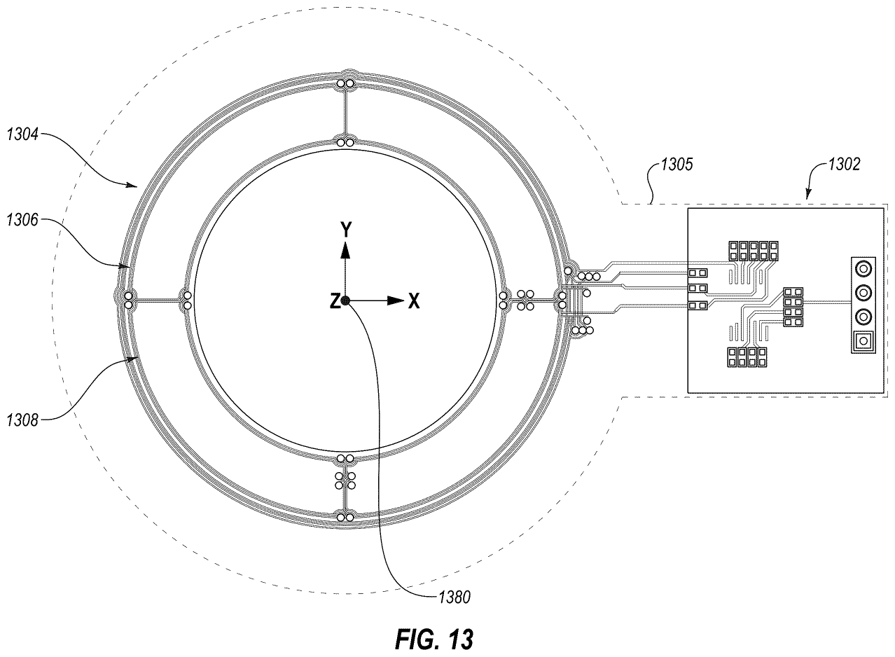

FIG. 13 is a top-down view of an apparatus 1300 for inductive angular position sensing that is known by the inventors of this disclosure. In one or more examples, apparatus 1300 includes an oscillator coil 1304, a first sense coil 1306, and a second sense coil 1308, which are arranged on, or in, a PCB 1305. A position sensing circuitry 1302 is operably coupled to the coils for sensing the angular position of a target (e.g., a planar annular target) adapted to rotate about a center axis 1380. In this approach, PCB 1305 including the coils has an area that covers or spans over at least an area of the planar annular target (i.e., the entire 360-degree area). Compare apparatus 1300 of FIG. 13 with apparatus 100 of FIGS. 1, 2, 3, and 4 according to one of more examples.

Advantageously, in one or more examples, an inductive angular position sensing apparatus of the disclosure is to sense an angular position of a target over a measurement range of 360 degrees with use of a substrate and coil design that is only a portion of the 360-degree area (e.g., only a 180-degree area, as stated in the non-limiting title of the disclosure). Such a design may facilitate the reduction in the size of the substrate/PCB and the coils and/or reduce the cost of the sensor.

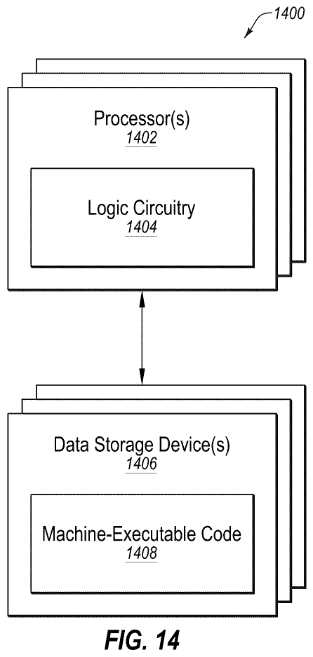

It will be appreciated by those of ordinary skill in the art that functional elements of examples disclosed herein (e.g., functions, operations, acts, processes, and/or methods) may be implemented in any suitable hardware, software, firmware, or combinations thereof. FIG. 14 illustrates non-limiting examples of implementations of functional elements disclosed herein. In some examples, some or all portions of the functional elements disclosed herein may be performed by hardware specially implemented for carrying out the functional elements.

FIG. 14 is a block diagram of circuitry 1400 that, in some examples, may be used to implement various functions, operations, acts, processes, and/or methods disclosed herein. The circuitry 1400 includes one or more processors 1402 (sometimes referred to herein as “processor 1402”) operably coupled to one or more data storage devices (sometimes referred to herein as “storage 1406”). Storage 1406 includes machine-executable code 1408 stored thereon and processor 1402 include a logic circuitry 1404. Machine-executable code 1408 includes information describing functional elements that may be implemented by (e.g., performed by) a logic circuitry 1404. Logic circuitry 1404 is adapted to implement (e.g., perform) the functional elements described by machine-executable code 1408. Circuitry 1400, when executing the functional elements described by machine-executable code 1408, should be considered as special purpose hardware for carrying out functional elements disclosed herein. In some examples, processor 1402 may perform the functional elements described by machine-executable code 1408 sequentially, concurrently (e.g., on one or more different hardware platforms), or in one or more parallel process streams.

When implemented by logic circuitry 1404 of processor 1402, machine-executable code 1408 adapts processor 1402 to perform operations of examples disclosed herein. For example, machine-executable code 1408 may be to adapt processor 1402 to perform at least a portion or a totality of operations associated with apparatus 100 for inductive angular position sensing according to one or more examples, including a portion of method 1000 of FIG. 10 (e.g., act 1010 of method 1000).

Processor 1402 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to machine-executable code 1408 (e.g., software code, firmware code, hardware descriptions) related to examples of the present disclosure. It is noted that a general-purpose processor (may also be referred to herein as a host processor or simply a host) may be a microprocessor, but in the alternative, processor 1402 may include any conventional processor, controller, microcontroller, or state machine. Processor 1402 may also be implemented as a combination of computing devices, such as a combination of a DSP and a microprocessor, a plurality of microprocessors, one or more microprocessors in conjunction with a DSP core, or any other such configuration.

In some examples, storage 1406 includes volatile data storage (e.g., random-access memory (RAM)), non-volatile data storage (e.g., Flash memory, a hard disc drive, a solid-state drive, erasable programmable read-only memory (EPROM), etc.). In some examples, processor 1402 and storage 1406 may be implemented into a single device (e.g., a semiconductor device product, a system on chip (SOC), etc.). In some examples, processor 1402 and storage 1406 may be implemented into separate devices.

In some examples, machine-executable code 1408 may include computer-readable instructions (e.g., software code, firmware code). By way of non-limiting example, the computer-readable instructions may be stored by storage 1406, accessed directly by processor 1402, and executed by processor 1402 using at least logic circuitry 1404. Also by way of non-limiting example, the computer-readable instructions may be stored on storage 1406, transferred to a memory device (not shown) for execution, and executed by processor 1402 using at least logic circuitry 1404. Accordingly, in some examples, logic circuitry 1404 includes electrically configurable logic circuitry 1404.

In some examples, machine-executable code 1408 may describe hardware (e.g., circuitry) to be implemented in logic circuitry 1404 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, System Verilog, or very large-scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 1404 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine-executable code 1408 may include an HDL, an RTL, a GL description, a mask level description, other hardware description, or any combination thereof.

In examples where machine-executable code 1408 includes a hardware description (at any level of abstraction), a system (not shown, but including storage 1406) may be to implement the hardware description described by machine-executable code 1408. By way of non-limiting example, processor 1402 may include a programmable logic device (e.g., an FPGA or a PLC) and logic circuitry 1404 may be electrically controlled to implement circuitry corresponding to the hardware description into logic circuitry 1404. Also, by way of non-limiting example, logic circuitry 1404 may include hard-wired logic manufactured by a manufacturing system (not shown, but including storage 1406) according to the hardware description of machine-executable code 1408.

Regardless of whether machine-executable code 1408 includes computer-readable instructions or a hardware description, logic circuitry 1404 is adapted to perform the functional elements described by machine-executable code 1408 when implementing the functional elements of machine-executable code 1408. It is noted that although a hardware description may not directly describe functional elements, a hardware description indirectly describes functional elements that the hardware elements described by the hardware description are capable of performing.

As used in the present disclosure, references to things (including oscillator coils, sense coils, and paths, without limitation) being “at,” “in,” “on,” “arranged at,” “arranged in,” “arranged on” and like terms a support structure may refer to the things being arranged substantially within and/or on a surface of the support structure.

In addition, the terms “substantial” and “substantially,” as well as the term “generally,” in reference to a given parameter, property, or condition means and includes to a degree that one skilled in the art would understand that the given parameter, property, or condition is met with a small or moderate degree of variance. For example, a parameter that is substantially met may be at least about 85% met, at least about 90% met, at least about 95% met, or even at least about 99% met.

Further, the terms “module” or “component” may refer to specific hardware implementations to perform the actions of the module or component and/or software objects or software routines that may be stored on and/or executed by general purpose hardware (e.g., computer-readable media, processing devices, etc.) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” or “one or more of A, B, and C, etc.,” is used, in general such a construction is intended to include A alone, B alone, C alone, A and B together, A and C together, B and C together, or A, B, and C together, etc.

Any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

A non-exhaustive, non-limiting list of examples follows. Note that each of the examples listed below is explicitly and individually indicated as being combinable with all others of the examples listed below and examples discussed above. It is intended, however, that these examples are combinable with all other examples unless it would be apparent to one of ordinary skill in the art that the examples are not combinable.

Additional non-limiting examples of the disclosure include:

Example 1: An apparatus comprising: a support structure; and a set of coils on, or in, the support structure, the set of coils including: one or more oscillator coils having a coil winding pattern arranged at least generally as a half-circle arc-band-shaped ring indicating boundaries of a half annulus; a first sense coil having a coil winding pattern including first, second, third, and fourth lobes, respective lobes of the first, the second, the third, and the fourth lobes arranged at least generally as quarter-circle arc-band-shaped rings in respective quarter annulus regions of the half annulus; and a second sense coil having a coil winding pattern including fifth and sixth lobes, respective lobes of the fifth and the sixth lobes arranged at least generally as half-circle arc-band-shaped rings in respective outer and inner half annulus regions of the half annulus.

Example 2: The apparatus according to Example 1, wherein: the first, the second, the third, and the fourth lobes of the first sense coil arranged at least generally as the quarter-circle arc-band-shaped rings in the respective quarter annulus regions are substantially proportionally arranged in the half annulus including the outer and inner half annulus regions thereof; and the fifth and the sixth lobes of the second sense coil arranged at least generally as the half-circle arc-band-shaped rings in respective outer and inner annular regions are substantially proportionally arranged in the half annulus including the outer and inner half annulus regions thereof.

Example 3: The apparatus according to any of Examples 1 and 2, wherein: the first lobe is arranged at least generally in an outer left quarter annulus region of the half annulus; the second lobe is arranged at least generally in an outer right quarter annulus region of the half annulus; the third lobe is arranged at least generally in an inner left quarter annulus region of the half annulus; and the fourth lobe is arranged at least generally in an inner right quarter annulus region of the half annulus.

Example 4: The apparatus according to any of Examples 1 through 3, wherein: the fifth lobe is generally coextensive with the first and the second lobes in the outer half annulus region of the half annulus; and the sixth lobe is generally coextensive with the third and the fourth lobes in the inner half annulus region of the half annulus.

Example 5: The apparatus according to any of Examples 1 through 4, wherein: respective lobes of the first and the fourth lobes of the first sense coil comprise one of a positive lobe or a negative lobe, and respective lobes of the second and the third lobes of the first sense coil comprise the other one of the positive lobe or the negative lobe; and the fifth lobe of the second sense coil comprises one of a positive lobe or a negative lobe, and the sixth lobe of the second sense coil comprises the other one of the positive lobe or the negative lobe.

Example 6: The apparatus according to any of Examples 1 through 5, wherein: the support structure comprises a printed circuit board (PCB); and the set of coils arranged generally in the half annulus comprise conductive traces in, or on, multiple layers of the PCB.

Example 7: The apparatus according to any of Examples 1 through 6, comprising: a target, the target including a target body to rotate about the axis, the target body having a generally planar annular shape, the target body comprising: an outer annulus region including a first outer half annulus region and a second outer half annulus region, at least a substantial portion of the first outer half annulus region comprising conductive material, the second outer half annulus region comprising non-conductive material; and an inner annulus region including a first inner half annulus region and a second inner half annulus region, the first inner half annulus region adjacent the first outer half annulus region, the second inner half annulus region adjacent the second outer half annulus region, at least a substantial portion of the second inner half annulus region comprising conductive material, the first inner half annulus region comprising non-conductive material.

Example 8: The apparatus according to any of Examples 1 through 7, wherein: respective ones of the at least substantial portions of the first outer half annulus region and the second inner half annulus region comprising the conductive material define a crescent shape; and respective regions outside of the respective crescent shapes in the first outer half annulus region and the second inner half annulus region comprise the non-conductive material.

Example 9: The apparatus according to any of Examples 1 through 8, comprising: a position sensing circuitry to: generate an excitation signal in the one or more oscillator coils to produce a varying magnetic field to induce first and second sense signals in the first and the second sense coils, respectively, the varying magnetic field disturbed in accordance with an angular position of the target which modulates the first and the second sense signals to produce modulated first and second sense signals; receive the modulated first and second sense signals from the first and the second sense coils, respectively; and demodulate the modulated first and second sense signals to produce demodulated first and second position signals, respectively, wherein respective ones of the demodulated first and second position signals exhibit one (1) cycle for every full rotation of the target.

Example 10: The apparatus according to any of Examples 1 through 9, comprising: the position sensing circuitry to: calculate an angular position of the target at least partially based on the demodulated first and second position signals.

Example 11: An apparatus comprising: a target, the target including a target body to rotate about an axis, the target body having a generally planar annular shape, the target body comprising: an outer annulus region including a first outer half annulus region and a second outer half annulus region, at least a substantial portion of the first outer half annulus region comprising conductive material, the second outer half annulus region comprising non-conductive material; and an inner annulus region including a first inner half annulus region and a second inner half annulus region, the first inner half annulus region adjacent the first outer half annulus region, the second inner half annulus region adjacent the second outer half annulus region, at least a substantial portion of the second inner half annulus region comprising conductive material, the first inner half annulus region comprising non-conductive material.

Example 12: The apparatus according to Example 11, wherein: respective ones of the at least substantial portions of the first outer half annulus region and the second inner half annulus region comprising the conductive material define a crescent shape, and respective regions outside of the respective crescent shapes in the first outer half annulus region and the second inner half annulus region comprise the non-conductive material.

Example 13: The apparatus according to any of Examples 11 and 12, comprising: a support structure; and a set of coils on, or in, the support structure, the set of coils arranged at least generally in a half annulus centered about the axis, the set of coils including: one or more oscillator coils having a coil winding pattern arranged at least generally as a half-circle arc-band-shaped ring indicating boundaries of the half annulus; a first sense coil having a coil winding pattern including first, second, third, and fourth lobes, respective lobes of the first, the second, the third, and the fourth lobes arranged at least generally as quarter-circle arc-band-shaped rings in respective quarter annulus regions of the half annulus; and a second sense coil having a coil winding pattern including fifth and sixth lobes, respective lobes of the fifth and the sixth lobes arranged at least generally as half-circle arc-band-shaped rings in respective outer and inner half annulus regions of the half annulus.

Example 14: The apparatus according to any of Examples 11 through 13, wherein: in a first angular position of the target, the at least substantial portion of the first outer half annulus region comprising the conductive material of the target body is to cover, in the outer half annulus region of the half annulus, at least portions of the first and the second lobes of the first sense coil and the fifth lobe of the second sense coil, and in a second angular position of the target, the at least substantial portion of the second inner half annulus region comprising the conductive material of the target body is to cover, in the inner half annulus region of the half annulus, at least portions of the third and the fourth lobes of the first sense coil and the sixth lobe of the second sense coil.

Example 15: An apparatus comprising: a support structure; and a set of coils on, or in, the support structure, the set of coils arranged at least generally in a half annulus centered about an axis, the set of coils comprising: one or more oscillator coils having a coil winding pattern arranged at least generally along or within boundaries of the half annulus; a first sense coil including a first continuous path defining a number of first lobes, respective lobes of the number of first lobes substantially proportionally arranged in the half annulus; and a second sense coil including a second continuous path defining a number of second lobes, the number of second lobes greater than the number of first lobes, respective lobes of the number of second lobes substantially proportionally arranged in the half annulus.

Example 16: The apparatus according to Example 15, wherein: respective lobes of the number of first lobes arranged at least generally as arc-band-shaped rings in the half annulus; and respective lobes of the number of second lobes arranged at least generally as arc-band-shaped rings in the half annulus.

Example 17: The apparatus according to any of Examples 15 and 16, comprising: a target, the target including a target body to rotate about an axis, the target body having a generally planar annular shape, the target body comprising: an outer annulus region including a first outer half annulus region and a second outer half annulus region, at least a substantial portion of the first outer half annulus region comprising conductive material, the second outer half annulus region comprising non-conductive material; and an inner annulus region including a first inner half annulus region and a second inner half annulus region, the first inner half annulus region adjacent the first outer half annulus region, the second inner half annulus region adjacent the second outer half annulus region, at least a substantial portion of the second inner half annulus region comprising conductive material, the first inner half annulus region comprising non-conductive material.

Example 18: The apparatus according to any of Examples 15 through 17, wherein: respective ones of the at least substantial portions of the first outer half annulus region and the second inner half annulus region comprising conductive material define a crescent shape; and respective regions outside of the respective crescent shapes in the first outer half annulus region and the second inner half annulus region comprise non-conductive material.

Example 19: The apparatus according to any of Examples 15 through 18, comprising: a position sensing circuitry to: generate an excitation signal in the one or more oscillator coils to produce a varying magnetic field to induce first and second sense signals in the first and the second sense coils, respectively, the varying magnetic field disturbed in accordance with an angular position of the target which modulates the first and the second sense signals to produce modulated first and second sense signals; receive the modulated first and second sense signals from the first and the second sense coils, respectively; and demodulate the modulated first and second sense signals to produce demodulated first and second position signals, respectively, wherein respective ones of the demodulated first and second position signals exhibit one (1) cycle for every full rotation of the target.

Example 20: The apparatus according to any of Examples 15 through 19, wherein: the number of first lobes is two (2); and the number of second lobes is four (4).

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An apparatus comprising:
a support structure; and
a set of coils on, or in, the support structure, the set of coils including:
one or more oscillator coils having a coil winding pattern arranged at least generally as a half-circle arc-band-shaped ring indicating boundaries of a half annulus;
a first sense coil having a coil winding pattern including first, second, third, and fourth lobes, respective lobes of the first, the second, the third, and the fourth lobes arranged at least generally as quarter-circle arc-band-shaped rings in respective quarter annulus regions of the half annulus; and
a second sense coil having a coil winding pattern including fifth and sixth lobes, respective lobes of the fifth and the sixth lobes arranged at least generally as half-circle arc-band-shaped rings in respective outer and inner half annulus regions of the half annulus.

2. The apparatus of claim 1, wherein:
the first, the second, the third, and the fourth lobes of the first sense coil arranged at least generally as the quarter-circle arc-band-shaped rings in the respective quarter annulus regions are substantially proportionally arranged in the half annulus including the outer and inner half annulus regions thereof; and
the fifth and the sixth lobes of the second sense coil arranged at least generally as the half-circle arc-band-shaped rings in respective outer and inner annular regions are substantially proportionally arranged in the half annulus including the outer and inner half annulus regions thereof.

3. The apparatus of claim 1, wherein:
the first lobe is arranged at least generally in an outer left quarter annulus region of the half annulus;
the second lobe is arranged at least generally in an outer right quarter annulus region of the half annulus;
the third lobe is arranged at least generally in an inner left quarter annulus region of the half annulus; and
the fourth lobe is arranged at least generally in an inner right quarter annulus region of the half annulus.

4. The apparatus of claim 3, wherein:
the fifth lobe is generally coextensive with the first and the second lobes in the outer half annulus region of the half annulus; and
the sixth lobe is generally coextensive with the third and the fourth lobes in the inner half annulus region of the half annulus.

5. The apparatus of claim 1, wherein:
respective lobes of the first and the fourth lobes of the first sense coil comprise one of a positive lobe or a negative lobe, and respective lobes of the second and the third lobes of the first sense coil comprise the other one of the positive lobe or the negative lobe; and
the fifth lobe of the second sense coil comprises one of a positive lobe or a negative lobe, and the sixth lobe of the second sense coil comprises the other one of the positive lobe or the negative lobe.

6. The apparatus of claim 1, wherein:
the support structure comprises a printed circuit board (PCB); and
the set of coils arranged generally in the half annulus comprise conductive traces in, or on, multiple layers of the PCB.

7. The apparatus of claim 1, comprising:
a target, the target including a target body to rotate about the axis, the target body having a generally planar annular shape, the target body comprising:
an outer annulus region including a first outer half annulus region and a second outer half annulus region, at least a substantial portion of the first outer half annulus region comprising conductive material, the second outer half annulus region comprising non-conductive material; and
an inner annulus region including a first inner half annulus region and a second inner half annulus region, the first inner half annulus region adjacent the first outer half annulus region, the second inner half annulus region adjacent the second outer half annulus region, at least a substantial portion of the second inner half annulus region comprising conductive material, the first inner half annulus region comprising non-conductive material.

8. The apparatus of claim 7, wherein:
respective ones of the at least substantial portions of the first outer half annulus region and the second inner half annulus region comprising the conductive material define a crescent shape; and
respective regions outside of the respective crescent shapes in the first outer half annulus region and the second inner half annulus region comprise the non-conductive material.

9. The apparatus of claim 7, comprising:
a position sensing circuitry to:
generate an excitation signal in the one or more oscillator coils to produce a varying magnetic field to induce first and second sense signals in the first and the second sense coils, respectively, the varying magnetic field disturbed in accordance with an angular position of the target which modulates the first and the second sense signals to produce modulated first and second sense signals;
receive the modulated first and second sense signals from the first and the second sense coils, respectively; and
demodulate the modulated first and second sense signals to produce demodulated first and second position signals, respectively,
wherein respective ones of the demodulated first and second position signals exhibit one (1) cycle for every full rotation of the target.

10. The apparatus of claim 9, comprising:
the position sensing circuitry to:
calculate an angular position of the target at least partially based on the demodulated first and second position signals.

11. An apparatus comprising:
a target, the target including a target body to rotate about an axis, the target body having a generally planar annular shape, the target body comprising:
an outer annulus region including a first outer half annulus region and a second outer half annulus region, at least a substantial portion of the first outer half annulus region comprising conductive material, the second outer half annulus region comprising non-conductive material; and
an inner annulus region including a first inner half annulus region and a second inner half annulus region, the first inner half annulus region adjacent the first outer half annulus region, the second inner half annulus region adjacent the second outer half annulus region, at least a substantial portion of the second inner half annulus region comprising conductive material, the first inner half annulus region comprising non-conductive material.

12. The apparatus of claim 11, wherein:
respective ones of the at least substantial portions of the first outer half annulus region and the second inner half annulus region comprising the conductive material define a crescent shape, and
respective regions outside of the respective crescent shapes in the first outer half annulus region and the second inner half annulus region comprise the non-conductive material.

13. The apparatus of claim 11, comprising:
a support structure; and
a set of coils on, or in, the support structure, the set of coils arranged at least generally in a half annulus centered about the axis, the set of coils including:
one or more oscillator coils having a coil winding pattern arranged at least generally as a half-circle arc-band-shaped ring indicating boundaries of the half annulus;
a first sense coil having a coil winding pattern including first, second, third, and fourth lobes, respective lobes of the first, the second, the third, and the fourth lobes arranged at least generally as quarter-circle arc-band-shaped rings in respective quarter annulus regions of the half annulus; and
a second sense coil having a coil winding pattern including fifth and sixth lobes, respective lobes of the fifth and the sixth lobes arranged at least generally as half-circle arc-band-shaped rings in respective outer and inner half annulus regions of the half annulus.

14. The apparatus of claim 13, wherein:
in a first angular position of the target, the at least substantial portion of the first outer half annulus region comprising the conductive material of the target body is to cover, in the outer half annulus region of the half annulus, at least portions of the first and the second lobes of the first sense coil and the fifth lobe of the second sense coil, and
in a second angular position of the target, the at least substantial portion of the second inner half annulus region comprising the conductive material of the target body is to cover, in the inner half annulus region of the half annulus, at least portions of the third and the fourth lobes of the first sense coil and the sixth lobe of the second sense coil.

15. An apparatus comprising:
a support structure; and
a set of coils on, or in, the support structure, the set of coils arranged at least generally in a half annulus centered about an axis, the set of coils comprising:
one or more oscillator coils having a coil winding pattern arranged at least generally along or within boundaries of the half annulus;
a first sense coil including a first continuous path defining a number of first lobes, respective lobes of the number of first lobes substantially proportionally arranged in the half annulus; and
a second sense coil including a second continuous path defining a number of second lobes, the number of second lobes greater than the number of first lobes, respective lobes of the number of second lobes substantially proportionally arranged in the half annulus.

16. The apparatus of claim 15, wherein:
respective lobes of the number of first lobes arranged at least generally as arc-band-shaped rings in the half annulus; and
respective lobes of the number of second lobes arranged at least generally as arc-band-shaped rings in the half annulus.

17. The apparatus of claim 15, comprising:
a target, the target including a target body to rotate about an axis, the target body having a generally planar annular shape, the target body comprising:
an outer annulus region including a first outer half annulus region and a second outer half annulus region, at least a substantial portion of the first outer half annulus region comprising conductive material, the second outer half annulus region comprising non-conductive material; and
an inner annulus region including a first inner half annulus region and a second inner half annulus region, the first inner half annulus region adjacent the first outer half annulus region, the second inner half annulus region adjacent the second outer half annulus region, at least a substantial portion of the second inner half annulus region comprising conductive material, the first inner half annulus region comprising non-conductive material.

18. The apparatus of claim 17, wherein:
respective ones of the at least substantial portions of the first outer half annulus region and the second inner half annulus region comprising conductive material define a crescent shape; and
respective regions outside of the respective crescent shapes in the first outer half annulus region and the second inner half annulus region comprise non-conductive material.

19. The apparatus of claim 17, comprising:
a position sensing circuitry to:
generate an excitation signal in the one or more oscillator coils to produce a varying magnetic field to induce first and second sense signals in the first and the second sense coils, respectively, the varying magnetic field disturbed in accordance with an angular position of the target which modulates the first and the second sense signals to produce modulated first and second sense signals;
receive the modulated first and second sense signals from the first and the second sense coils, respectively; and
demodulate the modulated first and second sense signals to produce demodulated first and second position signals, respectively,
wherein respective ones of the demodulated first and second position signals exhibit one (1) cycle for every full rotation of the target.

20. The apparatus of claim 15, wherein:
the number of first lobes is two (2); and
the number of second lobes is four (4).
